(19) United States
(12) Patent Application Publication
(10) Pub. No.: US 2006/0047363 A1
(43) Pub. Date: Mar. 2, 2006

(54) Machine vision system for lab workcells

(76) Inventors: Philip J. Farrelly, Short Hills, NJ (US); Scott Bartolett, Bridgewater, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/945,196

(22) Filed: Sep. 20, 2004

Related U.S. Application Data
(60) Provisional application No. 60/605,790, filed on Aug. 31, 2004.

(51) Int. Cl. G06F 19/00

(52) U.S. Cl. 700/245

(57) ABSTRACT

A robotic laboratory automation system includes a vision feedback apparatus with one or more teaching plates adapted for placement in a microplate or other specimen holder of a laboratory instrument or stack to represent the location of the microplate. The vision feedback system is adapted to control the robotic manipulator to automatically adjust the location of the manipulator to a position adjacent to a teaching plate upon locating a pattern on the teaching plate and then store the coordinates of the determined position. With the stored position coordinates the robot can return to the determined positions previously represented by the location of teaching plates to locate an actual microplate or specimen holder at the determined position without the vision feedback system.

### CROSS REFERENCE TO RELATED APPLICATIONS

This application claims the benefit of the filing date of U.S. Provisional Patent Application No. 60/605,790 filed Aug. 31, 2004 (attorney reference number HUDCON 3.8-001), the disclosure of which is hereby incorporated herein by reference.

### FIELD OF THE INVENTION

The present invention relates to laboratory automation systems. More particularly, the invention involves a laboratory work cell robot configured for vision navigation for learning workcell positions for automating microplate manipulation in the workcell.

### BACKGROUND OF THE INVENTION

Pharmaceutical and biotechnology companies produce and work with larger and larger numbers of compounds and processes, sometimes numbering in the millions. Such applied processes may involve, for example, drug discovery, high throughput screening, genomics, and proteomics. Many of such processes (although not all) revolve around the use of samples within the microplate format. The microplate allows large numbers of samples to be processed in a small area. Originally developed with 96 wells, the microplate footprint has expanded to 384, 1536, and even more wells within the same footprint.

These microplates are used in a variety of processes such as cell-based assays, ELISA assays, LC/MS analysis, and purifications. These processes, as well as the tasks of distributing the materials among plates, require the use of a variety of instruments that have been developed for use with the microplate format. These include liquid handlers, pipettors, dispensers, readers, washers, barcode labelers and readers, sealers, incubators, thermal cyclers, and others.

Many of these instruments are used manually. An operator stands in front of the individual instrument to place plates on it and activates the instrument's function. This can become a tedious task if large numbers of plates need to be processed.

If a way can be developed to successively feed stacks of plates into an instrument, a single user can accomplish more work with less error. The user can load the instrument stack and walk away. However, even with such “walkaway automation” since most of these processes require several instruments, there is often some degree of manual movement of microplates from one instrument to another as the chain of required events is processed.

Often, more advanced automation solutions are desired with the goal to completely automate an entire process such as a cell-based assay or ELISA. There are several ways to increase automation for microplate instruments: custom built instrument stacks; interchangeable stackers; cylindrical robot arms with stacks; articulated robotic arms and Linear track robotic arms.

Stacker devices work well but are limited in functionality to feeding plates to a single instrument. Articulated arms can offer a good degree of capability, but are more cumbersome to set up and operate, and are often more expensive. Linear track robotic arms can be very powerful within large scale automated systems, but these solutions are very expensive and often require long lead times to install or modify if new configurations are desired.

One example of an automated solution is the PlateCrane E™ offered by Hudson Control Group, Inc. This apparatus is a cylindrical robot arm. While early generation cylindrical robots were designed to feed labware from multiple stacks to a single instrument, the PlateCrane E™ represented an improvement over such systems. The robot added a new dimension to this concept with the ability to integrate with not only any robot-friendly microplate-based instrument on the market, but also with the ability to integrate to more than one such instrument within a workcell. This brought a new range of possibilities for increasing the walkaway automation for various processes.

With such a system it is possible to automate gripping and moving plates among multiple instruments in order to accomplish several steps in a process. For example, from a stack to a dispenser to a washer to a reader. The cylindrical robot may be connected to two identical instruments performing the same process to provide plates from stacks to both instruments. This permits a higher throughput “parallel operation”, since the instrument execution time (such as a reader taking a measurement) is often the slowest step in the process.

Several of the same instruments which have different functionality may also be connected with such a cylindrical robot, allowing rapid handling of processes without changeover requirements for hardware. Examples would be washers in 96 and 384 well format, or bulk dispensers primed with different reagents.

Similarly, different instruments may be connected to a single robot, allowing each instrument to operate independently from its own input and output stacks. This cost-effective and space-effective capability allows a single robot to perform multiple tasks.

Such a robotic apparatus is able to quickly provide integrations to a wide variety of lab automation instruments. However, with increased functionality comes increased complexity. For example, in order for such a robotic apparatus to move microplates or other specimen/sample holder device such as a Petri dish between multiple stacks and the nest of multiple instruments, the device must be pre-programmed with the particular coordinates of each location in the work cell so the machine knows how to return to each position. This process typically involves manual input from a user by which the user adjusts the plate gripper of robotic device to move it to each location in a work cell to contact a plate in the stacks or nest positions at each desired location. Once at a particular desired position the coordinates for the location are stored or recorded into the system. The time taken for such a process is further complicated considering that robotic apparatus may have several axis of control that need to be manipulated in order to move the gripper to each location. Such a process may need to be repeated when the work cell configuration is modified or the system is reset. It is desired to develop a system to simplify such a setup process.

### SUMMARY OF THE INVENTION

The invention relates to a system for learning specimen holder locations in a work cell of a laboratory for automated handling of specimen holders. In one embodiment of the system, a robotic manipulator is adapted for automated manipulation of a specimen holder. The robotic manipulator preferably has a plurality of ranges of motion for retrieving or depositing a specimen holder at a plurality of positions in equipment of the work cell of the robotic manipulator. One or more teaching targets or teaching plates may be adapted to represent a specimen holder for placement in the equipment of the work cell. The teaching device is adapted for providing visual information to a vision feedback control system. The vision feedback control apparatus coupled with the robotic manipulator controls the plurality of ranges of motion of the robotic manipulator in response to detecting the visual information of the teaching plate to automatically position the robotic manipulator to an orientation adjacent to the teaching plate. The vision feedback control apparatus is also configured for storing positioning information of the robotic manipulator for retrieving or depositing a specimen holder at a location represented by the teaching plate. A stored coordinate controller also automatically controls returning the robotic manipulator to an orientation represented by the stored positioning information previously determined by the vision feedback control apparatus in conjunction with locating a teaching plate.

Another embodiment of the invention also relates to a system for learning specimen holder locations in a work cell of a laboratory for automated handling of specimen containers having a robot means for handling of specimen containers at a plurality of positions in equipment of a work cell of the robot means. In the system a targeting means or teaching device represents a specimen container and may be adapted to conform to nesting positions of equipment of the work cell. The teaching means also includes a locator pattern. The system also includes an automated visual control means for automatically learning orientations associated with the teaching means by repeatedly capturing images of the teaching means, detecting the locator pattern, adjusting the robot means in response to the detected locator pattern and storing coordinates if the locator pattern coincides with a predetermined locator pattern. An additional non-visual operation control means may also be included for automatically controlling the robot means to repeatedly retrieve or deposit a specimen holder at a position in the plurality of positions represented by the stored coordinates learned by the automated visual control means.

In a method for automated learning of stack and instrument nest positions in a work cell by an automated laboratory specimen handler is also disclosed. In the method, one or more teaching devices such as teaching plates, each having a visual pattern, are placed in a stack or instrument nest of the automated laboratory specimen handler. The perimeter of the teaching plates have been adapted to the perimeter of a specimen holder receptacle of a stack or instrument nest. The orientation of the automated laboratory specimen handler is automatically controlled in at least two ranges of motion in response to a detection of the visual pattern of a teaching plate by processing captured digital images of the visual pattern. Coordinates are stored for the laboratory specimen handler after determining coincidence between the detected visual pattern and a previously stored visual pattern. Then, the orientation of the automated laboratory specimen handler is automatically controlled in the at least two ranges of motion to return to a learned location represented by the stored coordinates to deposit or retrieve a specimen handler without controlled processing of imaging data associated with a visual pattern of the teaching plate.

In still another embodiment, the system for learning specimen holder locations in a work cell of a laboratory for automated handling of specimen holders includes a robotic manipulator adapted for automated manipulation of a specimen holder. The robotic manipulator has a plurality of ranges of motion for retrieving or depositing a specimen holder at a plurality of positions in equipment of the work cell of the robotic manipulator. The system includes a target corresponding to a specimen holder position in the equipment of the work cell being adapted for providing visual information for a vision feedback control system. The vision feedback control apparatus of the system is coupled with the robotic manipulator for controlling the plurality of ranges of motion of the robotic manipulator in response to detecting the visual information of the target to automatically position the robotic manipulator to an orientation adjacent to the target. The vision feedback control apparatus is configured for storing positioning information of the robotic manipulator for retrieving or depositing a specimen holder at a location represented by the target. A stored coordinate controller of the system automatically returns the robotic manipulator to an orientation represented by the stored positioning information previously determined by the vision feedback control apparatus in conjunction with locating the target.

Additional aspects of the invention will be apparent from a review of the following disclosure and claims.

### BRIEF DESCRIPTION OF THE DRAWINGS

FIG. 1 is a representation of a configuration of a laboratory workcell automation system configured with a vision learning system of the invention;

FIG. 2 is a top elevation view of a workcell having a laboratory workcell automation system configured with a vision learning system of the invention;

FIG. 3 is a side elevation view of the laboratory work cell automation system of FIG. 1;

FIG. 4 is a block diagram control schematic of a controller for controlling the laboratory work cell automation system configured as a vision learning system;

FIG. 5 is an imaging device of the vision learning system that may be coupled to the laboratory workcell automation system illustrated in FIG. 1;

FIG. 6 is a manual control device for changing orientation of the manipulator of the laboratory robot along its preferred axes of control;

FIG. 7 is a perspective view of teaching plate adapted to represent a microplate with a homing or target pattern for use with a vision learning system of the invention;

FIG. 8 is top elevation view of a teaching plate;

FIG. 9 is a flow chart of steps in a control method for automated learning of a plate location in a laboratory work cell.

### DETAILED DESCRIPTION

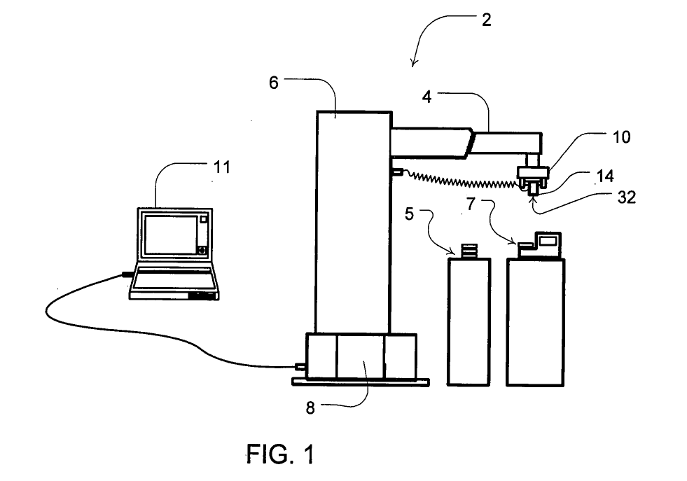

Referring to the figures, where like numerals indicate similar features, a laboratory automation system of the invention includes a robotic manipulator 2 adapted for automated manipulation of a laboratory specimen or sample holder such as a microplate. For example, as illustrated in FIGS. 1-3, the preferred robotic manipulator 2 is a cylindrical robot. However, the robotic manipulator may alternatively include other robotic automation devices such as an articulated arm or SCARA arm.

The preferred cylindrical robot includes an arm 4, a tower 6, a base 8, a gripper 10, a controller 12 and an imaging device 14. As will be explained in more detail, the robot with the equipped imaging device 14 can home in on a target or a common pattern on multiple teaching plates, and identify and store each specimen holder position in a laboratory work cell associated with the teaching plates for later automated handling.

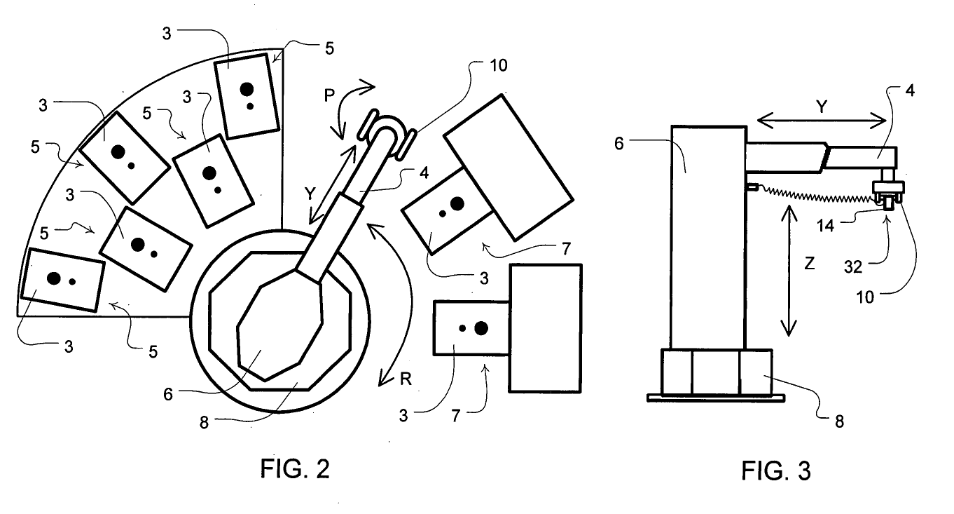

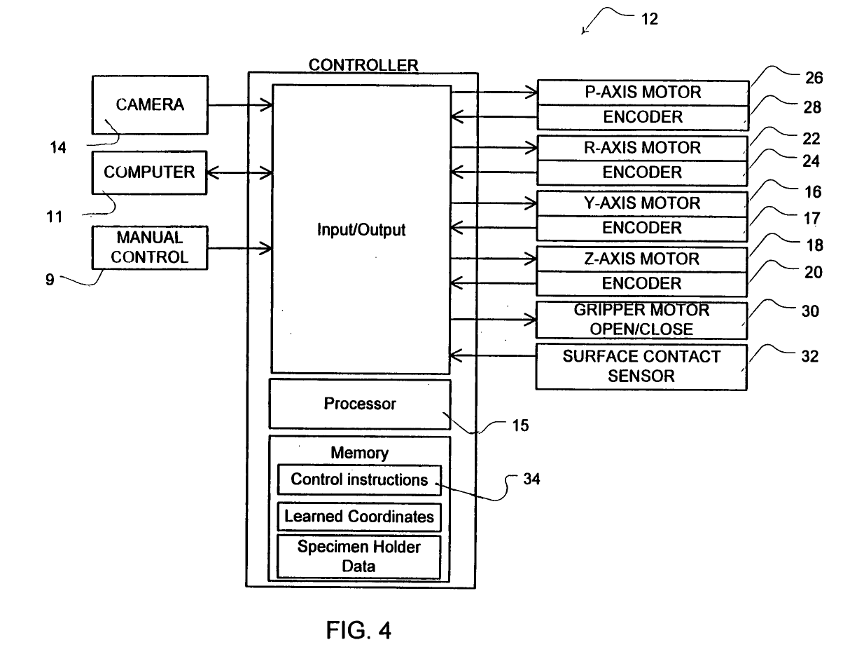

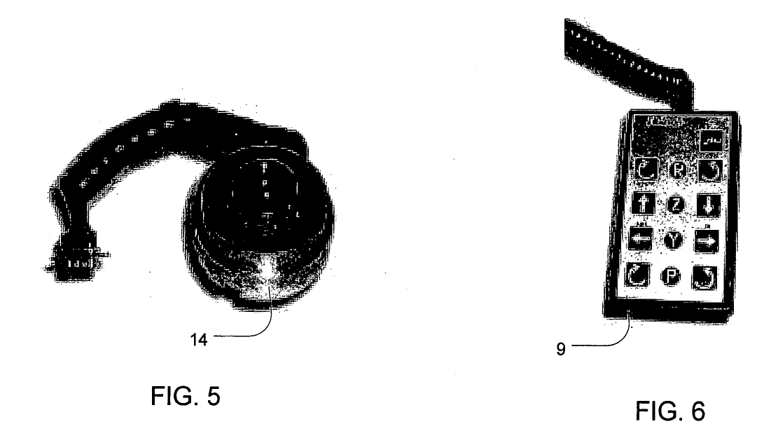

To these ends, the robotic manipulator 2 is preferably configured for automated control in a plurality of ranges of motion. In the cylindrical robot example, the arm 4 extends or telescopes relative to the tower 6 in directions along axis Y as illustrated in FIGS. 2 and 3. The controller 12 of the robot includes a motor control loop coupled with a processor 15 to change the length of the arm 4 along the Y axis. For example, processor 15 of the robot is adapted to send a signal to Y-axis stepper motor 16 to move the Y-axis stepper motor 16 until the arm extends or retracts to a desired position. Optionally, a Y-axis encoder 17, such as an optical encoder, coupled to the Y-axis stepper motor 16 provides the processor 15 with closed loop feed back to confirm translation to the desired position set by the processor 15.

The arm 4 is coupled to the tower 6 to also permit the arm to translate in directions along axis Z up and down the height of the tower 6. Thus, one side of the arm resides in a track of the tower 6 and is preferably coupled with a Z-axis motor 18 of the controller 12 which for preference is a stepper motor. The processor 15 is adapted to transmit a signal to the Z-axis motor 18 to raise or lower the arm along the Z-axis. The Z-axis motor may also be coupled to a Z-axis encoder 20 to provide closed loop control over the translation of the arm along the z-axis.

The tower 6 is configured to rotate about the base 8 in a circular direction R. The processor 15 is configured to generate a signal to a motor control circuit preferably including an R-axis motor 22 which may be a stepper motor. This motor control circuit may also include an R-axis encoder for close loop feedback to the processor.

Optionally, the gripper may include a motor control circuit to provide controlled pivoting or rotation of the gripper 10 relative to the arm 4 in rotational direction P. Thus, the processor 15 may also generate a signal to a P-axis motor 26 such as a stepper motor which also preferably includes P-axis encoder 28 to provide closed loop feed back control over the rotation of the gripper.

With these motion controls, the processor can retrieve data from memory representing a particular position and orientation of the gripper 10 of the robot arm 4 using R, Z, Y and P coordinates at a desired time in accordance with a laboratory automation program. Thus, when retrieved or otherwise input to the system as set points for the arm 4 and gripper 10, the processor can automatically control the arm 4 and gripper 10 to repeatedly return to the particular position and orientation associated with the stored coordinates.

Preferably, in addition to the above positioning and orientation control, the processor may also generate a control signal to open or close the gripper control motor 30 for selectively gripping or releasing plates. The gripper also includes an optional surface contact sensor 32 such as a pressure switch to indicate contact between the gripper and a surface against which the gripper may contact. Contact with a surface by the surface contact sensor 32 transmits a signal to the processor to indicate a moment of contact.

The imaging device 14 (e.g., a digital camera) of the robotic manipulator provides a component of a vision feed back teaching system. Generally, the image device or camera is used to guide the robot arm so as to save the position coordinates of desired positions for later use by the robot arm in performing its desired tasks. Such an imaging device 14 preferably includes a lens, a charge-coupled device (CCD) and A/D converter for generating a digital image that can be transmitted to the processor for image analysis. The preferred imaging device is adapted as a removable component of the system. In this way, the imaging device 14 may be mounted to the gripper 10 for a learning routine but it may be easily removed for normal operation once the robot has learned all desired positions in a work cell. Preferably, the imaging device 14 is configured for coupling in a central location of gripper 10 on the gripper end of the arm 4. Such a central location maximizes the field of view of the camera with regard to capturing images of the homing or target pattern of a plate location intended for gripping by the gripper 10. Optionally, the gripper 10 may be disengaged from the arm 4 and the image device may be configured with a structure that permits it to couple with the robot arm in the place of the removed gripper 10.

In conjunction with control instructions 34 of the controller 12 and the processor 15, the imaging device 14 provides a means for automated learning of plate positions (e.g., determining R, Z, Y and P coordinates) in a laboratory work cell for subsequent automated operation by the system. With the motion control loops along the P-axis, R-axis, Z-axis, and Y-axis as previously described, the controller 12 is adapted or configured with control instructions (e.g., integrated circuits or software) to identify a desired target pattern associated with a teaching device using the imaging device 14 and to adjust the position and orientation of the arm 4 and gripper end of the arm 4 to locate the gripper 10 (equipped with the imaging device 14) at a position adjacent to the target pattern, such as the target patterns illustrated on teaching plates of FIGS. 2, 7 and 8. The adjustment of the arm 4 and gripper 10 in this automated learning process are for the purpose of determining absolute coordinates for retrieving or depositing microplates or other sample holder at a location in a laboratory work cell that the plates will be utilized or stored. While this control methodology may reside within the controller of the robot, optionally, such control may be implemented as software in coupled computer 11, which may issue control instructions to and receive data from the robotic manipulator 2 along a communications link between these devices (e.g., RS232, SCSI, USB, or other communications connection, etc.)

In the preferred methodology for learning sample/specimen holder positions, a targeting device such as a teaching plate 3 may be used. Preferably, the device or teaching means is a target adapted to a form that may reside within a stack 5 position, instrument nest 7 or other position in a work cell in which the actual sample holders would need to be placed. In a preferred embodiment, the perimeter of the teaching plate 3 is adapted to conform to the footprint of a microplate. Thus, the teaching plate 3 may be placed in stacks 5 or other laboratory equipment or instrument nest 7 that will typically receive microplates (e.g., readers, washers, liquid handlers, pipettors, dispensers, sealers, bar code labelers, or other microplate-based instruments, etc.). During the learning procedure, the teaching plate or target may correspond to or otherwise represent a specimen holder (e.g., microplate) and it may temporarily take the place of the holder.

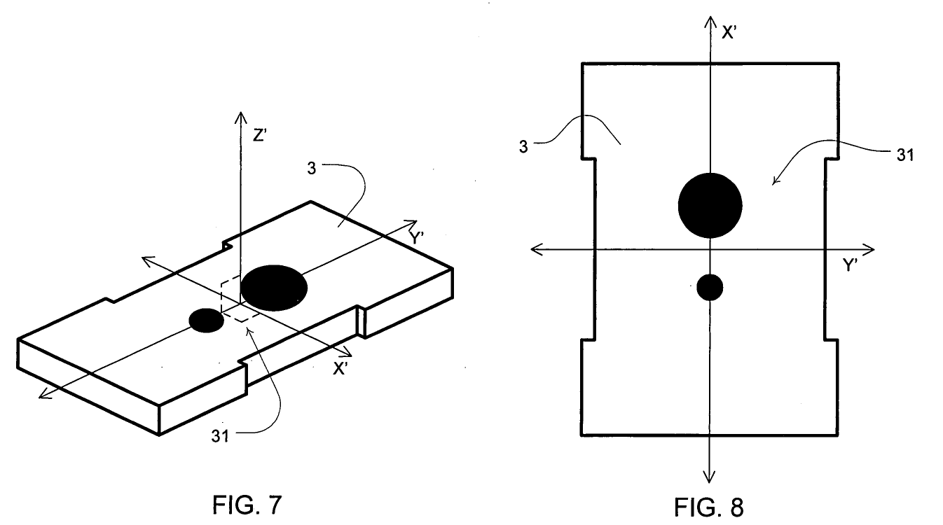

The teaching device or teaching plate 3 is beneficially adapted with a locator pattern. The locator pattern 31 is chosen to permit centering of the gripper over the plate position in which the teaching plate is employed (e.g., on the X-Y graphing axes illustrated in FIGS. 7 and 8. Moreover, the pattern 31 is also chosen to permit rotational orientation such that the gripper device may be properly aligned (e.g., parallel with the edges of the plate by rotation of the P-axis control) for closing the gripper device on the edges of a plate in the plate position represented by the teaching plate. In the preferred embodiment as illustrated in FIGS. 7 and 8, the locator pattern 31 is a shape pattern including two dark circles on a light background. These circles have different radii. The pattern is beneficially located on the teaching plate such that a midpoint of an imaginary line connecting the center points of the circles resides at the center of the plate. As those skilled in the art will recognize, this assists with maximizing the field of view of the centrally located imaging device when moving the imaging device over the teaching plate. However, those skilled in the art will recognize that such centering is not required. Moreover, other patterns may also be employed. However, a pattern that can be easily distinguished by the processor from the external perimeter of the chosen plate is desirable as illustrated by using circles with the rectangular plates.

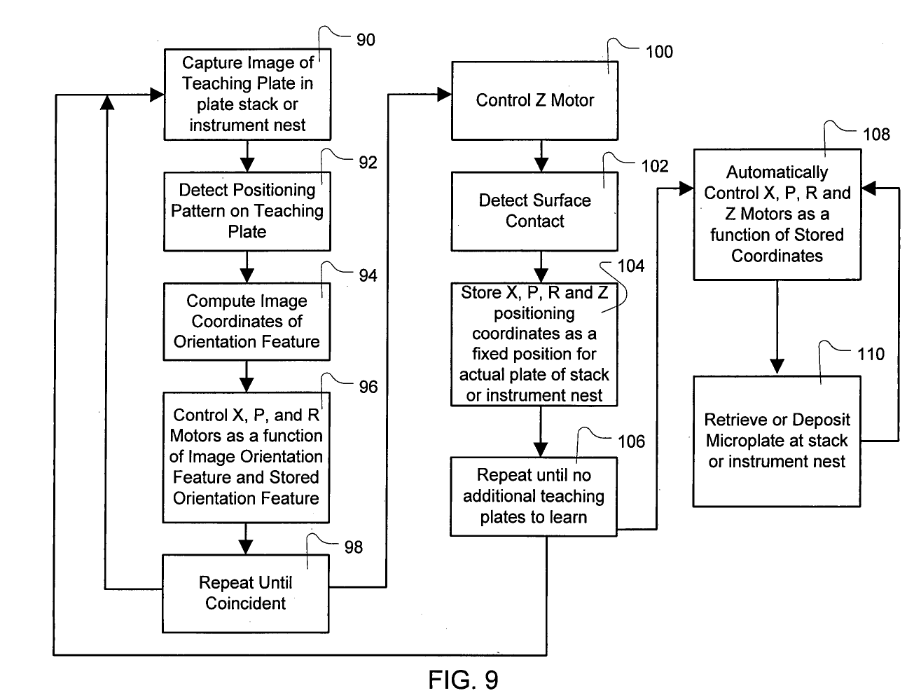

The preferred control methodology for the automated controlled learning of plate positions with the teaching plates 3 is illustrated in the flow chart of FIG. 9. With the imaging device 14, in step 90 an image of a teaching plate in a stack or instrument nest is captured by the imaging device 14 as a digital image. The digital image is then processed by the processor. In step 92, the processor scans the frame of the image to resolve the border and detect the locator pattern, such as the large and small circles illustrated in the figures.

When the detected pattern is confirmed, in step 94, the processor then computes image frame coordinates of the pixels of a locating or orientation feature of the desired pattern in the image frame. In the illustrated example, the equation for a line between the center points of the large and small circles are determined. Preferably, the midpoint of the line between the center points of the circles is also determined. In step 96, this computed information is then compared with a pre-determined/stored mid-point and line in image frame coordinates to determine whether there is a coincidence between the location and slope of the line in the image frame and the pre-determined/stored mid-point and line of a pre-determined/stored image. As will be discussed in more detail herein, the stored image is preferably determined during a calibration procedure.

If no coincidence is found, the processor computes in pixels a desired difference between the line and midpoint of the captured image relative to the pre-programmed mid-point and line from a pre-determined image. With the desired difference in pixels, a predetermined ratio of pixel frame movement to robot movement converts the pixel difference into a motion difference for moving the robot arm and/or gripper. After the arm/gripper is repositioned, a new image is captured and the steps are repeated from step 98 until the line and midpoint of the captured image and the line and midpoint of the predetermined/stored image are coincident (e.g., such that the stored and captured midpoints have the same X-Y image coordinates and the stored and captured line equations have the same slope).

Preferably, these above described steps and the consequent changes to the position of the arm 4 and gripper 10 are done in a single plane characterized by the X′-Y′ graph axes of FIGS. 7 and 8 and may be performed at a predetermined stored height on the Z′ graph axis above the surface of the plate (i.e., at a certain Z-axis control coordinate of the robotic system). This height above the plate may be, for example, 1-2 inches). This stored height is preferably a particular height above the teaching plate that has previously been used to acquire the stored image pattern (e.g., the stored midpoint and line equation) during calibration which will be discussed in more detail herein. Initially, the system may control adjustment of the arm and gripper on an X′-Y′ plane at an unknown height above the teaching plate in attempt to position and orient with respect to the teaching plate at the unknown height. The controller may then automatically repeat acquisition of the locater pattern and the determination of the R, Y and P coordinates at the stored height above the plate associated with the predetermined stored image (e.g., the stored midpoint and line data) after the height of the plate is determined. This permits the controller to confirm/refine the accuracy of the previously determined R, Y and P coordinates previously determined at the unknown height.

With the identified steps above, the positioning coordinates of the robot for the Y-axis control, P-axis control and the R-axis control are determined for the particular position learned. A determination of the Z coordinate relative to the teaching plate 3 (i.e., the position on the gripper 10 along the Z′ graph axis illustrated in FIG. 7) is then determined with the assistance of the surface contact sensor 30 located at the gripper end of the arm 4. Once having preliminarily determined Y, R and P coordinates and having these coordinates set by the processor so the that the gripper and arm is positioned at these coordinates, in step 100 the Z axis motor is controlled to lower the arm 4. In step 102, the surface contact sensor 30 will be triggered by detecting contact between the image device or the gripper arm and the teaching plate 3. The Z coordinate then can be determined as a function of the Z coordinate position of the arm when contact is established.

Alternatively to the contact sensor methodology, other range determination means may be used. For example, the image sensor may be utilized to calculate area of a pattern image to assess the distance to the plate surface. Those skilled in the art will recognize other devices for range detection and determination of the Z coordinate for the set points of the system.

In the event that the height of the actual plates used in a particular lab work cell differ from the height of the target or teaching plate, a common teaching plate 3 height may still be used. For this purpose, the memory of the controller, or optionally an attached computer, may include relative height information data (e.g., offset relative to the teaching plate) of various specimen holders or microplates for determining the relative Z′ axis position given the contact position determined with the contact sensor and the teaching plate. This data may be accessed with the control instructions of the controller or computer. Thus, when learning the Z coordinate (i.e. plate height) with a teaching plate having a height different from the microplate ultimately used in the laboratory environment, an offset may be taken into account when computing the Z coordinate. In this way, a common teaching plate may be used for teaching different work cell operations even though many different specimen holders may be utilized in different work cell operations.

In step 104, as a result of the vision controlled determination as described, the learned X, P, R and Z motion coordinates for the robotic control system are then stored as a fixed coordinate position that is associated with the stack or instrument in which the teaching plate 3 was located. Additional teaching plates can then be located and the positioning coordinates can be automatically determined by returning to step 90. If no further positions need to be learned, the robotic device in steps 108 and 110 can be automatically controlled to return to each of the learned positions in accordance with the stored coordinates for each to retrieve or deposit microplate or other sample containers represented by the learning plate at the learned positions of the stack(s) and/or instrument nest(s) in accordance with a laboratory automation program. In this regard, since the controller of the robot stores the learned stack(s) and instrument nest(s) positions as fixed coordinate positions, additional use of the vision feedback system is not necessary during laboratory automation using actual plates with specimens or testing samples. Thus, the camera may be removed and only utilized for setup of new work cell configurations when new stacks or instrument nests are added or existing ones are re-arranged.

For locating each additional plate/specimen holder position in a work cell, although a single teaching plate may be relocated to the next plate position by the user, multiple teaching plates may be employed. In this regard, the user may manually control the robot to move the gripper, for example, with a computer 11 or manual hand controller 9, so that a new teaching plate is in the proximity of the image device (e.g., in its field of view). Then the automated learning process for that teaching plate as discussed above may be employed to acquire the coordinates of the plate position represented by the teaching plate.

However, in some instances the controller 12 may have predefined coordinates for some plate positions within a work cell such as stack positions but these general coordinates may need to be confirmed or refined by the vision feedback system so that precise retrieval and deposit of plates by the robot may be controlled. In this situation, the controller 12 may include an automated routine for automatically sequentially visiting each generally pre-defined location to determine new precise coordinates for each by performing the learning procedure described above at each generally defined location. Thus, the vision system may be utilized to automatically acquire and store several plate positions without manual control by a user.

As previously noted, a calibration procedure may be utilized to predefine the target or locator pattern in the field of view of the imaging device. Thus, when first using the vision system, a procedure implemented by the controller, stores a mid-point and line in image frame coordinates from a captured image of the pattern from a teaching plate. This stored information is later used for comparison with the calculated mid-point and line of a captured pattern image of a teaching plate taken during the automated learning process as previously described. In this calibration procedure, the gripper would be positioned manually over a teaching plate, for example, by using a manual control device 9 or coupled computer 11, to orient the gripper on the X-Y graph axes so as to be in a centered position over the teaching plate using the Y-axis motor control and R-axis motor control. In addition, the P-axis controller would be manually adjusted so that the orientation of the sides of the gripper are in a correct orientation for gripping the sides of the teaching plate. Finally, the arm and gripper would be adjusted to a desired height (z-axis motor control) above the learning plate. Of course, this latter height adjustment step may be done automatically by the controller with a pre-stored height above the plate after contacting the plate with the surface contact sensor 32 and withdrawing the arm 4 via the Z-axis motor. This same desired height above a teaching plate is used during the learning procedure when determining the P, R, and Y in a constant plane set by the desired height. Once so oriented, the controller would store the captured image of the pattern and/or calculate and store the orienting features (e.g., the line and mid-point between the center points of the large and small circle) for subsequent use during the automated learning process.

The selection and recognition by the controller of the locating pattern for recording may be simplified with input of the user. In this regard, the system may display the image on a display screen of a connected computer 11 taken by the image device 14 during calibration. The system may prompt the user to click or select the pattern on a user interface showing the image. Thus, an algorithm for detecting the border of the locating pattern may start from the image coordinates selected by the user rather than scanning through the pixels of the entire image.

As part of the calibration procedure, a relationship between the motion of the robot and pixel movement in the field of view of the imaging device is also preferably determined. Thus, once the image pattern and/or orienting features (e.g., line and mid-point) are stored during calibration as previously described, each axis of motor control is separately adjusted a specified amount changing one coordinate at a time. (e.g., incrementing R, P, or Y coordinates). The resultant pixel movement of a new image pattern is compared to the stored image pattern for each axis change, for example by determining the change of image coordinates of the midpoint and the slope of the line. A ratio between the pixel movement and each motor axis movement (R, P and Y) is then determined and stored for use by the system in the automated learning process as previously described.

In use, with such a system, a plurality of teaching plates can be provided, each having the visual locating pattern. The user can manually place a plurality of such teaching plates at fixed positions where it is desired for the robotic manipulator to repeatedly return for automated operations. The vision control apparatus adapted to be coupled with a portion of the manipulator automatically controls the manipulator to locate each pattern and compute return coordinates for the fixed positions represented by the locations of each teaching plate. The robotic manipulator may then be automatically controlled to return to the desired positions with the return coordinates. Preferably, such automatic control returns the robotic manipulator to the fixed positions without the teaching plates or vision control apparatus, which may be removed. In this way the system learns nest positions of instruments or stacks in a microplate handling lab workcell.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for learning specimen holder locations in a work cell of a laboratory for automated handling of specimen holders comprising:
a robotic manipulator adapted for automated manipulation of a specimen holder, the robotic manipulator having a plurality of ranges of motion for retrieving or depositing a specimen holder at a plurality of positions in equipment of the work cell of the robotic manipulator;
a teaching plate adapted to represent a specimen holder for placement in the equipment of the work cell, the teaching plate adapted for providing visual information for a vision feedback control system; and
a vision feedback control apparatus coupled with the robotic manipulator for controlling the plurality of ranges of motion of the robotic manipulator in response to detecting the visual information of the teaching plate to automatically position the robotic manipulator to an orientation adjacent to the teaching plate, the vision feedback control apparatus configured for storing positioning information of the robotic manipulator for retrieving or depositing a specimen holder at a location represented by the teaching plate;
a stored coordinate controller for automatically returning the robotic manipulator to an orientation represented by the stored positioning information previously determined by the vision feedback control apparatus in conjunction with locating a teaching plate.

2. The system of claim 1 wherein the specimen holder is a microplate and the teaching plate conforms to the footprint of a microplate.

3. The system of claim 2 wherein the visual information is a shape pattern.

4. The system of claim 3 wherein the robotic manipulator comprises a cylindrical robot having at least three ranges of motion.

5. The system of claim 4 wherein the vision feedback control apparatus is configured to determine from the teaching plate positioning coordinates in a single plane based on feedback from an imaging device and wherein the vision feedback control apparatus is further configured to determine a positioning coordinate along an axis generally perpendicular to the plane, determined from a signal of a contact sensor representing contact with the teaching plate.

6. The system of claim 5 wherein the vision feedback control apparatus is configured with general positioning coordinates representing several specimen holder locations in the work cell and the vision feedback control apparatus comprises control instructions for automatically controlling the robotic manipulator to approach each location and in conjunction with a learning plate in each location, determine precise coordinates for subsequently retrieving or depositing specimen holders at each location.

7. A system for learning specimen holder locations in a work cell of a laboratory for automated handling of specimen containers comprising:
robot means for handling of specimen containers at a plurality of positions in equipment of a work cell of the robot means;
teaching means representing a specimen container and adapted to conform to nesting positions of equipment of the work cell, the teaching means including a locator pattern;
automated visual control means for automatically learning orientations associated with the teaching means by repeatedly capturing images of the teaching means, detecting the locator pattern, adjusting the robot means in response to the detected locator pattern and storing coordinates if the locator pattern coincides with a predetermined locator pattern;
non-visual operation control means for automatically controlling the robot means to repeatedly retrieve or deposit a specimen holder at a position in the plurality of positions represented by the stored coordinates learned by the automated visual control means.

8. The system of claim 7 wherein the teaching means conforms to a foot print of a microplate.

9. The system of claim 8 wherein the locator pattern comprises a circular shape centrally located on the teaching means to provide centering information with respect to the teaching means.

10. The system of claim 8 wherein robot means comprises a pivoting gripper, cylindrical base, telescoping arm.

11. The system of claim 10 further comprising a contact sensor, wherein the automated visual control means determines a height of the teaching means without imaging information by controlling the arm to lower to a position in contact with the teaching means indicated by a signal of the contact sensor.

12. The system of claim 12 further comprising control instructions for accessing height data representing a plurality of different height specimen holders associated with the teaching means and for adjusting the determined height by the height data.

13. A method for automated learning of stack and instrument nest positions in a work cell by an automated laboratory specimen handler, the method comprising the steps of:
placing one or more teaching plates having a visual pattern in a stack or instrument nest of the automated laboratory specimen handler, the perimeter of the teaching plates being adapted to the perimeter of a specimen holder receptacle of a stack or instrument nest;
automatically controlling the orientation of the automated laboratory specimen handler in at least two ranges of motion in response to a detection of the visual pattern of a teaching plate by processing captured digital images of the visual pattern;
storing coordinates for the laboratory specimen handler after determining coincidence between the detected visual pattern and a previously stored visual pattern;
automatically controlling the orientation of the automated laboratory specimen handler in the at least two ranges of motion to return to a learned location represented by the stored coordinates to deposit or retrieve a specimen handler without controlled processing of imaging data associated with a visual pattern of the teaching plate.

14. The method of claim 13 wherein the teaching plate conforms to the footprint of a microplate.

15. The method of claim 14 further comprising the steps of automatically controlling the automated laboratory specimen handler in a third range of motion until a contact sensor generates a signal indicating contact, the contact associated with a surface of the teaching plate; and storing a coordinate relative to the position of the automated laboratory specimen handler at the contact.

16. The method of claim 15 wherein the automated laboratory specimen handler comprises a cylindrical robot with a telescoping arm.

17. The method of claim 16 wherein the visual pattern comprises circular shapes from which a mid point and line are computed.

18. A system for learning specimen holder locations in a work cell of a laboratory for automated handling of specimen holders comprising:
a robotic manipulator adapted for automated manipulation of a specimen holder, the robotic manipulator having a plurality of ranges of motion for retrieving or depositing a specimen holder at a plurality of positions in equipment of the work cell of the robotic manipulator;
a target corresponding to a specimen holder position in the equipment of the work cell, the target adapted for providing visual information for a vision feedback control system; and
a vision feedback control apparatus coupled with the robotic manipulator for controlling the plurality of ranges of motion of the robotic manipulator in response to detecting the visual information of the target to automatically position the robotic manipulator to an orientation adjacent to the target, the vision feedback control apparatus configured for storing positioning information of the robotic manipulator for retrieving or depositing a specimen holder at a location represented by the target;
a stored coordinate controller for automatically returning the robotic manipulator to an orientation represented by the stored positioning information previously determined by the vision feedback control apparatus in conjunction with locating a teaching plate.

19. The system of claim 18 wherein the target comprises a teaching plate conforming to the footprint of a microplate.

20. The system of claim 19 wherein the visual information is a shape pattern.
